(19) United States
(12) Patent Application Publication
(10) Pub. No.: US 2007/0212943 A1
(43) Pub. Date: Sep. 13, 2007

(54) PCB MOUNTED CONNECTORS ASSEMBLY

(75) Inventor: ZHENG-HENG SUN, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,282

(22) Filed: Jul. 21, 2006

(30) Foreign Application Priority Data
Mar. 9, 2006 (CN) 200610034225.4

(51) Int. Cl. H01R 24/00

(52) U.S. Cl. 439/660

(57) ABSTRACT

A printed circuit board (PCB) includes at least two electrical connectors electrically connected thereto and a supporting element. The supporting element includes at least one supporting section connecting with the PCB. The at least two electrical connectors are enclosed in the supporting element. The supporting element is configured to define a gap between a substantial portion of a bottom surface of the supporting element and the PCB.

### 1. FIELD OF THE INVENTION

The present invention relates to printed circuit boards (PCBs), and particularly to a PCB with some electrical connectors.

### 2. DESCRIPTION OF RELATED ART

FIG. 1 shows a motherboard 40 of a server with four conventional Serial Advanced Technology Attachment (SATA) male connectors 50. Each of the SATA male connectors 50 is separately located on the motherboard 40 by a corresponding supporting element 52 mounted on the motherboard 40. One end of each connector 50 is electrically connected to the motherboard 40, and another end of each connector 50 is used for connecting a device such as a SATA hard disk.

However, so many SATA male connectors 50 consume too much space on the motherboard 40, and if more than four connectors 50 are needed, design and manufacturing process of the motherboard 40 will be complicated, thereby increasing cost of the motherboard 40.

What is desired, therefore, is to provide a PCB which readily holds multiple connectors yet saves space and with a less difficult manufacturing process.

### SUMMARY OF THE INVENTION

In one preferred embodiment, a printed circuit board (PCB) includes at least two electrical connectors electrically connected thereto and a supporting element. The supporting element includes at least one supporting section connecting with the PCB. The at least two electrical connectors are enclosed in the supporting element. The supporting element is configured to define a gap between a substantial portion of a bottom surface of the supporting element and the PCB.

Other advantages and novel features will become more apparent from the following detailed description when taken in conjunction with the accompanying drawings, in which:

### BRIEF DESCRIPTION OF THE DRAWINGS

FIG. 1 is an isometric view of a PCB with four conventional SATA male connectors;

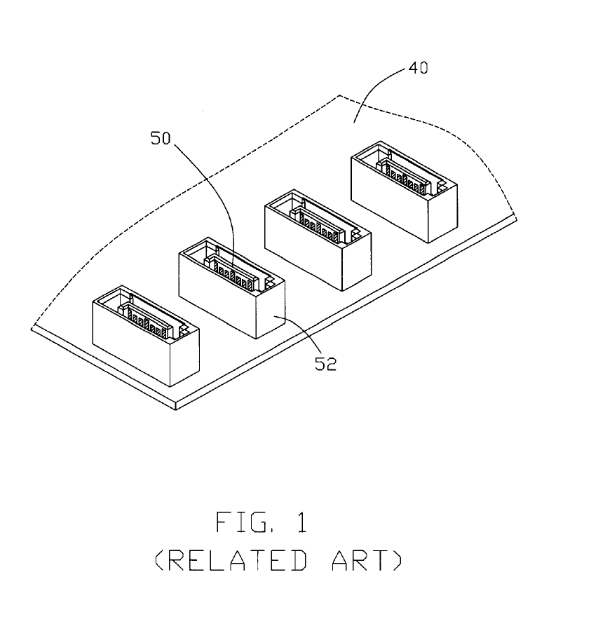

FIG. 2 is an isometric view of a PCB in accordance with a first preferred embodiment of the present invention; and

FIG. 3 is an isometric view of a PCB in accordance with a second preferred embodiment of the present invention.

### DETAILED DESCRIPTION OF THE INVENTION

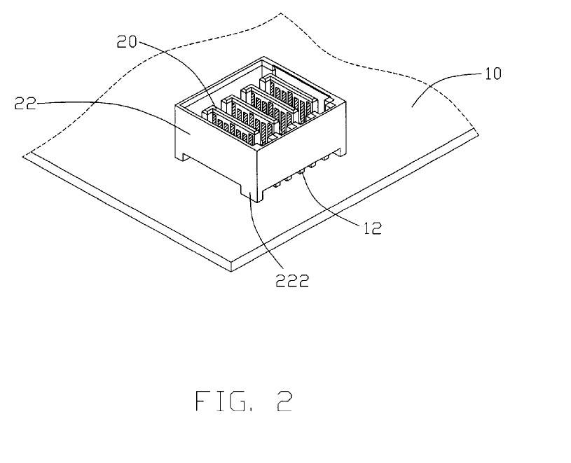

Referring to FIG. 2, a printed circuit board (PCB) 10 in accordance with a first preferred embodiment of the present invention is shown. The PCB 10 includes at least two electrical connectors 20 for electrically connecting some peripheral devices such as Serial Advanced Technology Attachment (SATA) hard disks. In this embodiment, an amount of the connector 20 is four and the electrical connectors 20 are SATA male connectors.

The PCB 10 further includes a supporting element 22 for locating the electrical connectors 20. The supporting element 22 is mounted on the PCB 10 by at least one supporting section such as four posts 222 extending from four corners of a bottom of the supporting element 22. The supporting element 22 is configured to leave a gap between the bottom of the element 22 and the PCB 10 such as two mm, so that space in and around the element 22 may be used for mounting devices such as surface mounted components (SMCs) 12 on the PCB 10 under the supporting element 22.

In this embodiment, the electrical connectors 20 are arranged side by side in a single line and located in the supporting element 22. One end of each connector 20 is electrically connected to the PCB 10, and another end of each connector 20 is used for connecting a device such as a SATA hard disk (not shown). Further, the four electrical connectors 20 are assembled within only one supporting element 22, thereby a manufacturing process of the PCBs using the present invention is simpler and thus saves on manufacturing cost.

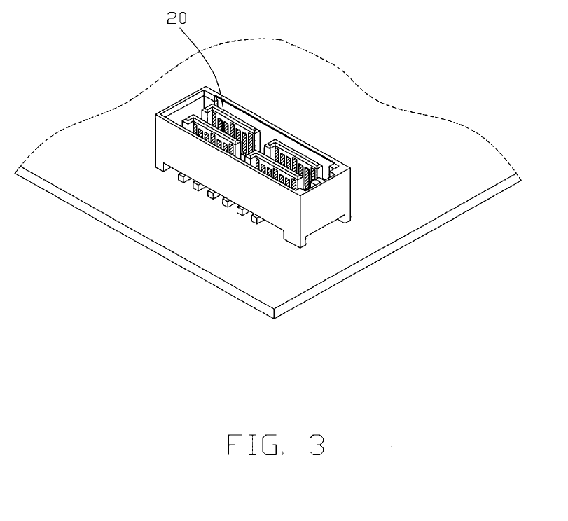

Referring also to FIG. 3, a printed circuit board (PCB) 10 in accordance with a second preferred embodiment of the present invention is shown. The second preferred embodiment is similar to the first preferred embodiment, except that the electrical connectors 20 are arranged in a 2×2 matrix pattern. The arrangement of the electrical connectors 20 also can be arranged in other patterns according to need.

It is to be understood, however, that even though numerous characteristics and advantages of the preferred embodiments have been set forth in the foregoing description, together with details of the structures and functions of the embodiments, the disclosure is illustrative only, and changes may be made in detail, especially in matters of shape, size, equivalent material and arrangement of parts within the principles of the invention to the full extent indicated by the broad general meaning of the terms in which the appended claims are expressed.

1. A printed circuit board (PCB) comprising:
at least two electrical connectors electrically connected thereto; and
a supporting element enclosing the at least two electrical connectors, and comprising at least one supporting section connecting with the PCB, the supporting element configured to define a gap between a substantial portion of a bottom surface of the supporting element and the PCB, wherein a plurality of surface mounted components (SMCs) are arranged on the PCB and within the gap.

2. The PCB as claimed in claim 1, wherein the at least one supporting section comprises four posts extending from four corners of a bottom of the supporting element.

3. The PCB as claimed in claim 1, wherein the at least two electrical connectors are Serial Advanced Technology Attachment (SATA) male connectors.

4. The PCB as claimed in claim 1, wherein the at least two electrical connectors are arranged in a line.

5. The PCB as claimed in claim 1, wherein the at least two electrical connectors are arranged in a matrix pattern.

6. A printed circuit board (PCB) comprising:
at least two electrical connectors; and
a supporting element mounted on the PCB, the at least two electrical connectors assembled together on the supporting element and electrically connected to the PCB, a bottom surface of the supporting element being spaced from the PCB a certain distance to accommodate a plurality of surface mounted components (SMCs).

7. The PCB as claimed in claim 6, wherein the supporting element comprises four posts extending from four corners of the bottom surface of the supporting element.

8. The PCB as claimed in claim 6, wherein the at least two electrical connectors are Serial Advanced Technology Attachment (SATA) male connectors.

9. The PCB as claimed in claim 6, wherein the at least two electrical connectors are arranged in a line.

10. The PCB as claimed in claim 6, wherein the at least two electrical connectors are arranged in a matrix pattern.

11. The PCB as claimed in claim 6, wherein the distance is two mm.
